(19) United States
(12) Patent Application Publication
(10) Pub. No.: US 2024/0291082 A1
(43) Pub. Date: Aug. 29, 2024

(54) BATTERY DRYING DEVICE

(71) Applicant: MANN+HUMMEL GmbH, Ludwigsburg (DE)

(72) Inventor: MARKUS KOLCZYK, Mundelsheim (DE)

(21) Appl. No.: 18/404,907

(22) Filed: Jan. 5, 2024

(30) Foreign Application Priority Data
Feb. 27, 2023 (EP) 23158678.5

(51) Int. Cl. H01M 50/141

(52) U.S. Cl. CPC H01M 50/141; H01M 2220/20

(57) ABSTRACT

A battery drying device includes a membrane disposed external to a battery housing of a battery, and configured to prevent liquid water from passing through the membrane and to allow gaseous water to pass through the membrane, a moisture adsorber disposed external to the battery housing and downstream from the membrane, and configured to absorb moisture in the gaseous water, and an adjustable connection valve disposed adjacent to the battery housing and downstream from the moisture adsorber, and configured to, in a regular operation mode, be open and allow air from which the moisture is absorbed by the moisture adsorber into the battery housing, and in a regeneration mode, be closed. The battery drying device further includes an adjustable regeneration valve interposed between the membrane and the moisture adsorber.

### CROSS-REFERENCE TO RELATED APPLICATION

This application claims the benefit of European Application No. 23158678.5 filed on Feb. 27, 2023, the entire disclosure of which is incorporated herein by reference for all purposes.

### BACKGROUND

Embodiments to a battery drying device for a battery, to a battery with a battery drying device, to a vehicle having a battery with a battery drying device, and to a method of operating a battery drying device.

A battery drying device for a battery is known from DE 10 2014 203 927 A1. The battery drying device has a housing which is inserted into an opening in a battery housing of a battery, hence the battery drying device being fully integrated into the battery housing. The battery drying device includes a drying agent that adsorbs moisture that enters the battery drying device via incoming air from inside the battery housing.

The battery drying device is equipped with a heating device with which the drying agent can be heated and adsorbed moisture can be released. During this regeneration process, an opening in battery drying device to the interior of the battery housing is closed and, at the same time, an outflow opening is opened through which the moisture from the drying agent can escape into the environment.

It is an object of the embodiments to operate a battery drying device with high efficiency over a long period of time.

### SUMMARY

The battery drying device according to the embodiments can be used for drying a battery, for example a vehicle battery in vehicles. The vehicle battery is used for general power supply in the vehicle and/or for driving an electric motor used to drive the vehicle.

The battery drying device can be used to efficiently remove moisture before it enters the interior of a battery or from the interior of the battery. For this purpose, the battery drying device has a drying housing in which a moisture adsorbing agent or drying agent is accommodated. An inlet opening is provided in the drying housing, which is covered by a membrane that keeps out liquid, in particular water, but could be permeable to water in the gaseous state. The membrane in the inlet opening enables pressure compensation in the interior of a battery housing of a battery, for example, in case of pressure differences due to a temperature change of the air in the battery housing. At the same time, the membrane prevents water entry from the outside into the battery drying device and into the battery.

A connection opening is also provided in the drying housing, the connection opening enabling a flow connection to the battery housing of the battery. A moisture adsorber means is arranged in the flow path between the inlet opening and the connecting opening, the moisture adsorber means dividing the interior of the drying housing in to separate chambers. An adjustable connection valve is inserted into the connection opening, which can be adjusted between a closed position and an open position.

The inlet opening and the connection opening are located in the drying housing in such a way that the moisture adsorbent is arranged in the flow path between these openings. This ensures that both the air from the outside flowing in via the inlet opening and the air from the battery housing flowing out via the connection opening are adsorbed in the moisture adsorber means.

A heating device is integrated into the battery drying device, by means of which the moisture adsorber means can be heated in order to remove the adsorbed moisture from the moisture adsorber means and thereby regenerate the moisture adsorber means. In particular, the heating means is designed to be electrically operable. During regular operation, the heating means is not active so that moisture can be adsorbed in the moisture adsorber means. This state corresponds to the operating mode in which the connecting valve is in an open position.

A further opening is integrated in the drying housing, which has the function of a regeneration opening and which is not connected to the battery housing. In particular, a flow connection with the environment can be established via the regeneration opening. An adjustable regeneration valve is inserted into the regeneration opening, which can be adjusted between a closed position and an open position. In the operating mode, the regeneration valve is closed.

To regenerate the moisture adsorber means, a regeneration mode is activated in which the connection valve located in the connection opening to the battery housing is set to a closed position, and at the same time the regeneration valve in the regeneration opening is set to the open position. The heating device is actuated in the regeneration mode. Due to the closed connection valve, it is ensured that the air in the drying housing loaded with moisture from the moisture adsorber means does not enter the battery housing, but is rather discharged to the environment via the open regeneration valve and the regeneration opening. As soon as the regeneration mode is finished, the heating device is switched off, the regeneration valve is closed and the connecting valve is opened again, whereupon the battery drying device is in the operating mode again.

In an advantageous embodiment, the regeneration opening and the inlet opening covered by the membrane are located on the same side of the moisture adsorber means. However, a configuration in which the inlet opening and the regeneration opening are located on opposite sides of the moisture adsorber means is also possible. The heating device, which serves to heat the moisture adsorber means in the regeneration mode, is designed, for example, as an electric heating rod.

According to still another advantageous embodiment, the battery drying device includes an electrically operated pump which serves to generate an air flow in the regeneration mode. The air flow can be directed through the moisture adsorber means, thereby significantly increasing the efficiency of drying the moisture adsorber means in the regeneration mode. The air flow is directed through the moisture adsorber means and can be discharged into the environment via the open regeneration opening.

Advantageously, the electrically driven pump is integrated into the drying housing. This has the advantage that the pump is protected from environmental influences and no additional space is required for the pump.

According to a further advantageous embodiment, the drying housing has a ventilation opening with an adjustable ventilation valve arranged therein, the ventilation opening and the regeneration opening being located on opposite sides of the moisture adsorber means. In the operating mode, the ventilation opening is closed, and in the regeneration mode, the ventilation opening is open so that a flow of air from the environment can be directed through the moisture adsorber means via the regeneration opening and discharged back into the environment via the ventilation opening. This design with ventilation opening and regeneration opening on opposite sides of the moisture adsorber means is combined in particular with the electrically operated pump, which is located for example on the same side as the moisture adsorber means as well as the regeneration opening. When the pump is actuated, air is drawn in from the environment and passed through the moisture adsorber means, whereupon the moisture-laden air is returned to the environment via the regeneration opening. In operating mode, both the ventilation opening and the regeneration opening are closed.

A control unit and a power supply unit may be associated with the battery drying device, wherein individual controllable units of the battery drying device are controlled via the control unit, in particular the valves and the heating device. The electrical power required for the control and the change of state of the individual controllable units is provided via the power supply unit.

Another aspect of the embodiments relates to a battery, in particular a vehicle battery having a battery drying device as described above. The battery drying device is located outside the battery housing, the drying housing and the battery housing advantageously being adjacent to each other. The flow connection is made via the connection opening, which is provided in the drying housing. The battery housing may also have a corresponding connection opening.

The embodiments further relate to a vehicle having a pre-described battery with which a pre-described battery drying device is associated.

Finally, the embodiments relate to a method of operating a pre-described battery drying device. In the method, the moisture adsorber means is dried in a regeneration mode by moving the connection valve to the closed position and the regeneration valve to the open position, whereupon the heating means is actuated. Conversely, the battery drying device may be operated in an operating mode without regenerating the moisture adsorbent means and without actuating the heating means as long as the connecting valve is in the open position and the regeneration valve is in the closed position.

### BRIEF DESCRIPTION OF DRAWINGS

A description will now be given as a non-limiting example of a form of several embodiments of a battery drying device. Reference will be made to the attached drawings, in which:

FIG. 1 is a schematic representation of a battery drying device next to a battery housing;

FIG. 2 is a battery drying device in another embodiment; and

FIG. 3 a battery drying device in yet another embodiment

In the figures, same components are provided with the same reference numerals.

### DETAILED DESCRIPTION

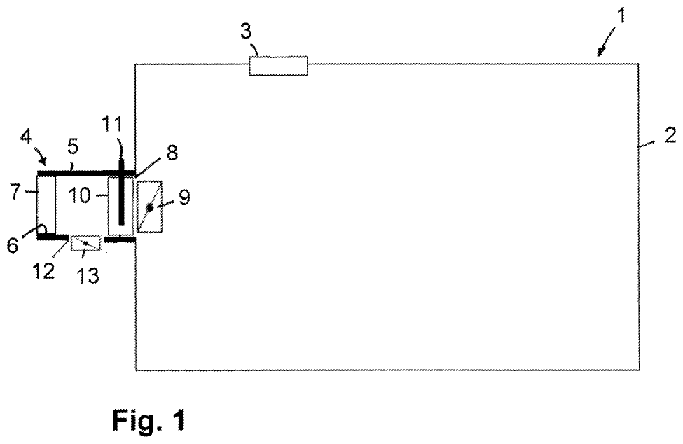

FIG. 1 schematically depicts a battery 1, for example a vehicle battery for an electric drive motor in a vehicle. The battery 1 includes a battery housing 2 in which battery cells are accommodated. A pressure relief valve 3 is integrated into the battery housing 2, which serves as an emergency degassing unit for reducing an increased internal pressure in the battery housing 2.

A battery drying device 4 is associated with the battery 1 for adsorbing moisture in the air passing through the battery drying device 4. In a drying housing 5 of the battery drying device 4, an inlet opening 6 with a membrane 7 is arranged, through which ambient air flows into the battery drying device 4 and further into the interior of the battery housing 2. The membrane 7 prevents water in liquid form from passing, but it is possible for water in gaseous form to pass through the membrane 7. The water in gaseous form is at least partially removed from the air flow through the battery drying device 4.

In the drying housing 5 of the battery drying device 4, there is also provided a connection opening 8 which is opposite the inlet opening 6 and which is aligned with a corresponding opening in the battery housing 2. An adjustable connection valve 9 is inserted in the connection opening 8, which can be adjusted between an open position and a closed position.

Inside the drying housing 5 a moisture adsorber means 10 is arranged in the flow path of the air passing through the drying housing 5 which adsorbs the moisture in the air flow. A heating device 11 is integrated into the moisture adsorber means 10, for example a heating rod.

A regeneration opening 12 is provided in the drying housing 5, in which an adjustable regeneration valve 13 is integrated. The regeneration opening 12 and the inlet opening 6 in are located on the same side of the moisture adsorber means 10, with respect to the air flow passed through it, and is thus located on the side facing away from the connection opening 8.

The battery drying device 4 can be operated in a regular operation mode and in a regeneration mode. In the regular operation mode, the connection valve 9 is open and the regeneration valve 13 is closed, so that ambient air can pass through the inlet opening 6 with the membrane 7. The moisture adsorber means 10 adsorbs the moisture in the air, and subsequently the air cleaned of the moisture enters the interior of the battery housing 2.

In the regeneration mode, the connection valve 9 is closed and the regeneration valve 13 is open. At the same time, the heating device 11 is actuated so that the moisture adsorber means 10 is heated and moisture is released from the moisture adsorber means 10 into the air in the drying housing 5, which can be released into the environment through the opened regeneration opening 12. After completion of the regeneration process, which is carried out for example at regular time intervals, the regeneration valve 13 is closed again and the connection valve 9 is opened and the heating device 11 is switched off. The battery drying device 4 is in the now again in the operating mode.

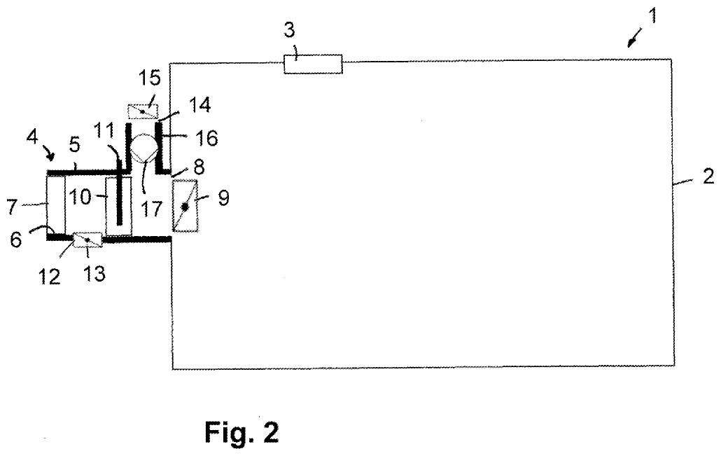

FIG. 2 shows another embodiment of a battery drying device 4 which, as in the first embodiment, is located on the side of a battery housing 2 of a battery 1. The battery drying device 4 has an inlet opening 6 with a membrane 7 in a drying housing 5. At the distal end, battery housing 2 has a connection opening 8 with a connection valve 9. A moisture adsorber means 10 with an integrated heating device 11 is located between the inlet opening 6 and the connection opening 8. A regeneration opening 12 with a regeneration valve 13 is located adjacent to the inlet opening 6. In this respect, the design corresponds to that of the first embodiment.

Furthermore, the battery drying device 4 has a ventilation opening 14 with an integrated, adjustable ventilation valve 15, the ventilation opening 14 being located at the end of a housing socket 16 which is formed integrally with the drying housing 5 and branches between the moisture adsorber means 10 and the connection opening 8. An electric pump 17 is integrated in the housing socket 16. When activating the electric pump 17, an air flow is generated from the environment through the housing socket 16 to the interior of the battery drying device 4.

In the regular operation mode, the regeneration valve 13 and the ventilation valve 15 are closed and the connection valve 9 is open. Both the heating device 11 and the electric pump 17 are switched off. Air can flow into the battery drying device 4 from the environment via the inlet opening 6 and the membrane 7.

In the regeneration mode, the connection valve 9 is closed, and at the same time the regeneration valve 13 and the ventilation valve 15 are opened. In addition, the heating device 11 is switched on and the electric pump 17 is actuated so that an air flow is drawn from the environment into the housing socket 16. This air flow passes through the moisture adsorber means 10, thereby ensuring effective drying of the moisture adsorber means 10.

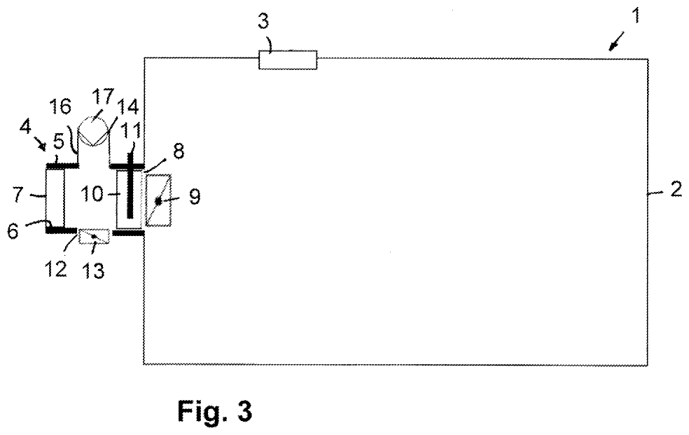

In the embodiment example according to FIG. 3, an electric pump 17 is also provided, which is located in a housing socket 16 with a ventilation opening 14 at its end. In this embodiment example, the housing socket 16 branches upstream of the moisture adsorber means 10. The housing socket 16 with the ventilation opening 14 is located opposite the regeneration opening 12 and is located on the same side of the moisture adsorber means 10 as the regeneration opening 12 as well as the inlet opening 6.

1. A battery drying device comprising:
a membrane disposed external to a battery housing of a battery, and configured to prevent liquid water from passing through the membrane and to allow gaseous water to pass through the membrane;
a moisture adsorber disposed external to the battery housing and downstream from the membrane, and configured to absorb moisture in the gaseous water;
an adjustable connection valve disposed adjacent to the battery housing and downstream from the moisture adsorber, and configured to:
in a regular operation mode, be open and allow air from which the moisture is absorbed by the moisture adsorber into the battery housing; and
in a regeneration mode, be closed;
an adjustable regeneration valve interposed between the membrane and the moisture adsorber and configured to:
in the regeneration mode, be open and allow air between the membrane and the moisture adsorber to be released into an environment external to the battery housing; and
in the regular operation mode, be closed position; and
an electrically operated pump interposed between the moisture adsorber and the adjustable connection valve, and configured to:
in the regeneration mode, generate a drying air flow for the moisture adsorber; and
in the regular operation mode, be switched off.

2. The battery drying device according to claim 1, further comprising a heating device integrated into the moisture adsorber, and configured to:
in the regeneration mode, heat the moisture adsorber so that the moisture is released from the moisture adsorber into the air between the membrane and the moisture adsorber; and
in the regular operation mode, be switched off.

3. The battery drying device according to claim 1, further comprising a drying housing disposed external to the battery housing, and comprising an inlet opening at which the membrane is disposed.

4. The battery drying device according to claim 3, wherein the drying housing further comprises a connection opening at which the moisture adsorber is disposed.

5. The battery drying device according to claim 4, wherein the drying housing further comprises a regeneration opening interposed between the inlet opening and the connection opening and at which the adjustable regeneration valve is disposed.

6. The battery drying device according to claim 5, wherein the drying housing further comprises a ventilation opening, the ventilation opening and the regeneration opening respectively being arranged on opposite sides of the moisture adsorber.

7. The battery drying device according to claim 6, wherein the battery drying device further comprises an adjustable ventilation valve disposed adjacent to the ventilation opening, and configured to:
in the regeneration mode, be open and allow air from the environment into the ventilation opening; and
in the regular operation mode, be closed.

8. The battery drying device according to claim 6, wherein the electrically operated pump is disposed downstream from the ventilation opening, and is further configured to draw the air allowed into the ventilation opening.

9. A battery comprising the battery drying device according to claim 1.

10. A vehicle comprising the battery according to claim 9.

11. A method of operating a battery drying device, the method comprising:
controlling to dry a moisture adsorber disposed external to the battery housing and downstream from a membrane disposed external to a battery housing of a battery, the moisture adsorber being configured to absorb moisture in gaseous water, and the membrane being configured to prevent liquid water from passing through the membrane and to allow the gaseous water to pass through the membrane, the controlling to dry the moisture adsorber comprising:
closing an adjustable connection valve disposed adjacent to the battery housing and downstream from the moisture adsorber;
opening an adjustable regeneration valve interposed between the membrane and the moisture adsorber, to allow air between the membrane and the moisture adsorber to be released into an environment external to the battery housing; and
controlling an electrically operated pump interposed between the moisture adsorber and the adjustable connection valve, to generate a drying air flow for the moisture adsorber.

12. The method according to claim 11, further comprising controlling to operate in in a regular operation mode by:
opening the adjustable connection valve to allow air from which the moisture is absorbed by the moisture adsorber into the battery housing;
closing the adjustable regeneration valve; and
switching off the electrically operated pump.
